(19) United States
(12) Patent Application Publication
(10) Pub. No.: US 2013/0033862 A1
(43) Pub. Date: Feb. 7, 2013

(54) External Ballast Fixture

(71) Applicant: Kevin Yang, Lomita, CA (US)

(72) Inventor: Kevin Yang, Lomita, CA (US)

(21) Appl. No.: 13/196,470

(22) Filed: Aug. 2, 2011

(51) Int. Cl. F21V 7/00; F21S 4/00

(52) U.S. Cl. 362/235; 362/249.01

(57) ABSTRACT

An external ballast fixture includes a top panel plate having sidewalls, lamp sockets connected to the top panel plate and lamps mounted to the lamp sockets. The sidewalls enclose the lamps. A ballast panel opening is formed on the top panel. The ballast panel opening has a ballast panel opening left side and a ballast panel opening right side. A ballast panel has a concave area. The ballast panel has a ballast panel left edge and the ballast panel has a ballast panel right edge. The ballast panel left edge connects to the fixture top panel at a ballast panel opening left side.

### BACKGROUND OF THE INVENTION

1. Field of the Invention

The present invention relates to external ballast fixtures.

2. Description of the Prior Art

Traditionally, lighting fixtures have had ballast internally mounted. A variety of externally mounted ballast fixtures have been introduced on a variety of different designs.

### SUMMARY OF THE INVENTION

An external ballast fixture includes a top panel plate having sidewalls, lamp sockets connected to the top panel plate and lamps mounted to the lamp sockets. The sidewalls enclose the lamps. A ballast panel opening is formed on the top panel. The ballast panel opening has a ballast panel opening left side and a ballast panel opening right side. A ballast panel has a concave area. The ballast panel has a ballast panel left edge and the ballast panel has a ballast panel right edge. The ballast panel left edge connects to the fixture top panel at a ballast panel opening left side.

The ballast panel right edge connects to the fixture top panel at a ballast panel opening right side. The ballast housing is mounted within the concave area of the ballast panel between the ballast panel left edge and the ballast panel right edge. The ballast is exposed to the environment via the ballast panel opening. A top panel plate is located adjacent the ballast. A knockout opening is formed on the top panel plate.

A pair of sloped wing sections formed at the ballast panel concave area, wherein the sloped wing sections are flat. A row of ballast panel top vents are formed on the ballast panel top. A row of ballast panel bottom vents may also be formed on the pair of sloped wing sections below the row of ballast panel top vents. A pair of reflectors is installed between the sidewalls of the top panel plate. The ballast panel is bendable to engage with an underside of the top panel plate also called the fixture top panel.

### BRIEF DESCRIPTION OF THE DRAWINGS

FIG. 1 is a cross section view.

FIG. 2 is a top perspective view.

FIG. 3 is a bottom perspective view of a reflector member.

FIG. 4 is a bottom perspective view.

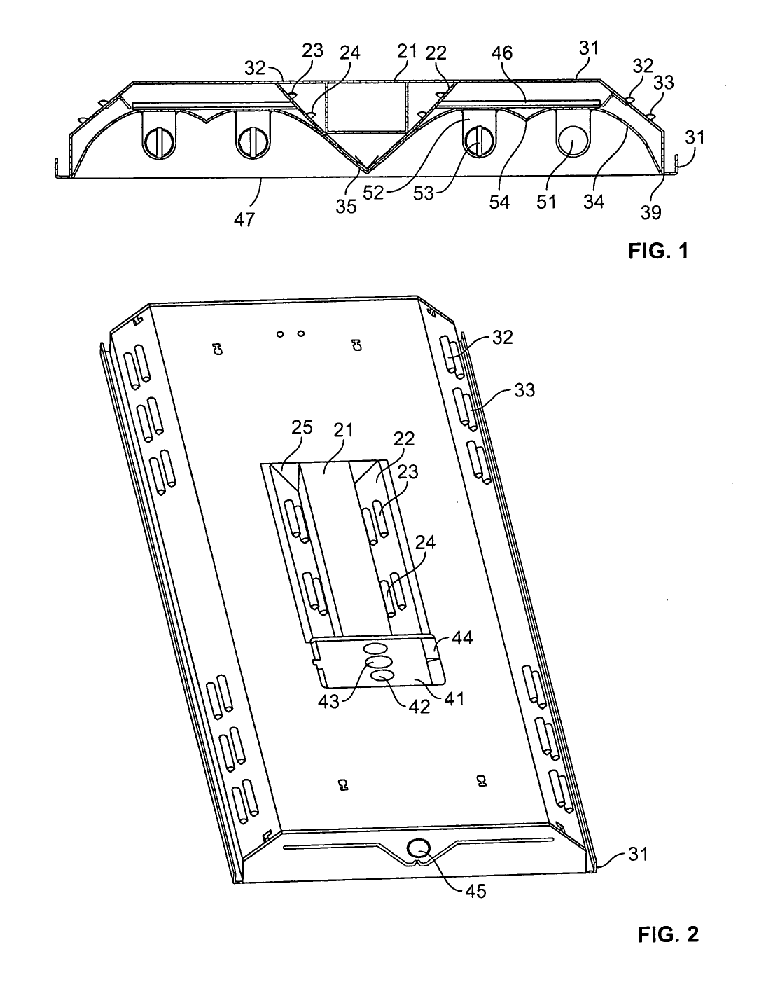

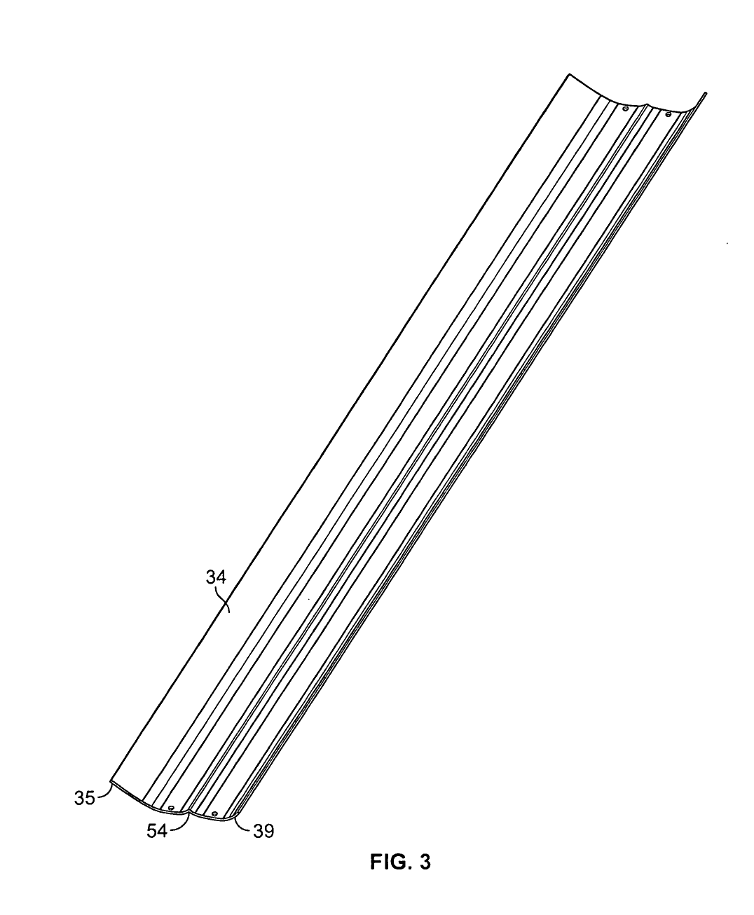

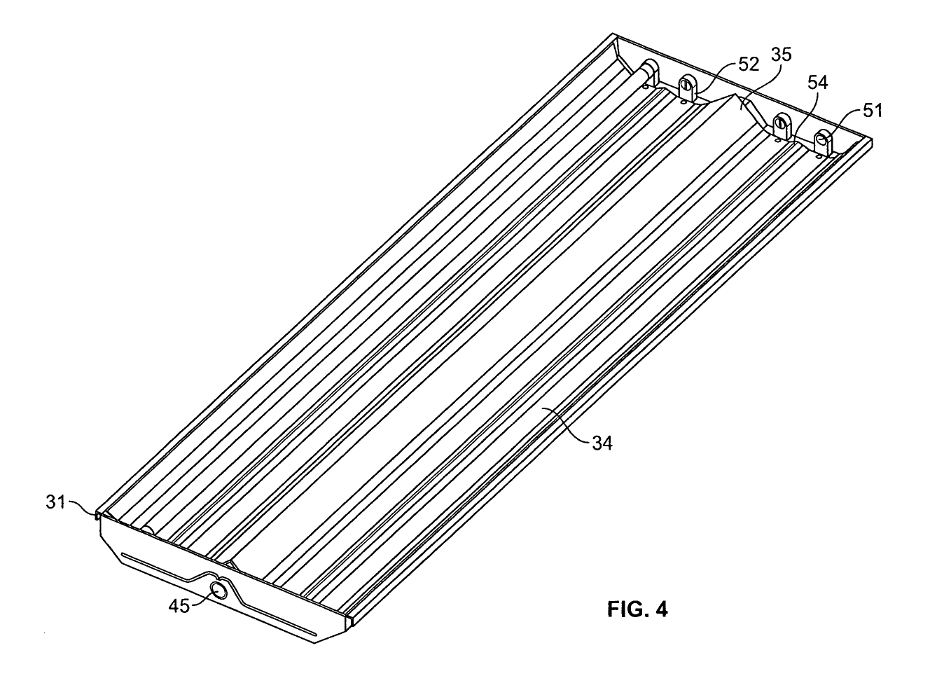

Similar reference numbers denote corresponding features throughout the attached drawings. The following call a list of elements can be a useful guide in referencing the elements of the drawings.

21 Electronic Ballast Housing

22 Ballast Panel

23 Ballast Panel Top Vent

24 Ballast Panel Bottom Vent

25 Rear Wall

31 Fixture Top Panel

32 Fixture Top Vent

33 Fixture Bottom Vent

34 Reflector

35 Reflector Inside Edge

39 Reflector Outside Edge

41 Top Panel Plate

42 Small Knockout Opening

43 Large Knockout Opening

44 Slot And Flap Connection

45 Side Knockout Opening

46 Reflector Base

51 First Lamp Socket

52 Second Lamp Socket

53 Swivel Connector

54 Reflector Peak

### DETAILED DESCRIPTION OF THE PREFERRED EMBODIMENT

The present invention includes a fixture with an electronic ballast mounted in an electronic ballast housing 21 located on a top portion of the picture. The electronic ballast housing is exposed to the outside environment, which could be the top of the ceiling, or air if the fixture is suspended. The electronic ballast housing 21 includes electronic components necessary to drive a number of florescent lights. The electronic ballast housing 21 is mounted on a ballast panel 22. The ballast panel 22 is preferably formed in a number of sections including a main section underneath the ballast and a pair of wing sections extending laterally in a sloped fashion away from the bottom edges of the ballast. The sloped wing sections have a number of vents disposed on the sections. The ballast panel 22 covers a ballast panel opening of the fixture top panel 31.

The vents are downwardly oriented openings preferably punched from a flat surface of the ballast panel 22. The vents are preferably formed as a flap oriented downward. The ballast panel 22 has a trapezoidal profile and is inserted so that it connects to an underside of the top surface of the fixture top panel. The row of ballast panel top vent 23 and the row of ballast panel bottom vent 24 are preferably formed as elongated horizontal openings.

The ballast panel 22 is preferably begins as a single rectangular sheet of metal that is bent at a lower portion such that the ballast panel is bendable to engage with an underside of the fixture top panel 31. The ballast panel 22 can be resiliently deformable and decrease in width. The ballast housing 21 can be mounted on top of the ballast panel 22 by being cradled within the ballast panel 22. The ballast panel 22 can be shorter than the ballast housing 21 so that the front and rear tips of the ballast housing protrude beyond the ballast panel 22.

A user changing the ballast can access the ballast from the exterior by sliding the ballast to remove one end of the ballast then to remove the other end of the ballast. A user changing the ballast can also access the ballast by removing the ballast panel 22 by bending the ballast panel inward to decrease its width and then to pull down the ballast panel. It is preferred that the ballast can be accessed from the outside. The ballast panel 22 may also lack a front wall and lack a rear wall 25 and only have the sloped wing sections to the left and right of the ballast housing. A user may also change the ballast by accessing the ballast from the lower side of the fixture through the front and rear openings if the front and rear walls of the ballast panel 22 are omitted.

A reflector base 46 can be mounted between the top panel 31 and the lower lens 47. The reflector 34 can be mounted to the reflector base 46. The reflector base 46 can be formed as a connector bar connecting a first lamp socket 51 to a second lamp socket 52. Each of the lamp sockets may have a swivel connector 53. The reflector preferably further includes a reflector peak 54 to define a pair of channels, namely a first reflector channel and a second reflector channel. The first reflector channel collects the light for the first lamp and the second reflector channel collects the light for the second lamp. The reflector has a pair of channels. The fixture has a pair of reflectors. The pair of reflectors connected together at a reflector inside edge 35. The reflector outside edge 39 presses against a side wall of the fixture.

The fixture top panel 31 also includes a fixture top vent 32 any fixture bottom vent 33 located on sidewalls of the fixture top panel 31. The fixture top panel also includes a hook channel along and left and right side of the fixture top panel. The fixture has a front panel and a rear panel both having side knockout openings 45 so that conduit can be connected to the fixture from panel or to the fixture rear panel. The row of fixture top vent 32 is located above a row of fixture bottom vent 33. The top vent 32 and a bottom vent 33 are preferably formed as elongated horizontal openings.

A top panel plate 41 can receive a large knockout opening 43 and a pair of small knockout openings 42. The knockout opening is a scored round opening that is initially closed with a round plate of metal, but then the round plate of metal can be pushed in by hand to create an opening for receiving conduit. The top panel plate is located adjacent the ballast and the ballast panel opening. The ballast panel opening exposes the ballast to the outside. The electronic ballast housing 21 may extend partially underneath the top panel plate 41. Preferably, the top panel plate 41 has a slot and flap connection 44. The top surface of the fixture top panel 31 may have a slot to receive a flap formed on the top panel plate 41.

Therefore, while the presently preferred form has been shown and described, it is to be understood that the present invention is not limited to the sole embodiment described above, but encompasses any and all embodiments within the scope of the following claims.

1. An external ballast fixture comprising:
a. a top panel plate having sidewalls;
b. lamp sockets connected to the top panel plate;
c. lamps mounted to the lamp sockets, wherein the sidewalls enclose the lamps;
d. a ballast panel opening formed on the top panel, wherein the ballast panel opening has a ballast panel opening left side and a ballast panel opening right side;
e. a ballast panel having a concave area, wherein the ballast panel has a ballast panel left edge and wherein the ballast panel has a ballast panel right edge, wherein the ballast panel left edge connects to the fixture top panel at a ballast panel opening left side and wherein the ballast panel right edge connects to the fixture top panel at a ballast panel opening right side; and
f. a ballast housing mounted within the concave area of the ballast panel between the ballast panel left edge and the ballast panel right edge, wherein the ballast is exposed to the environment via the ballast panel opening.

2. The external ballast fixture of claim 1, further comprising a top panel plate located adjacent the ballast.

3. The external ballast fixture of claim 2, further comprising a knockout opening formed on the top panel plate.

4. The external ballast fixture of claim 1, further comprising a pair of sloped wing sections formed at the ballast panel concave area, wherein the sloped wing sections are flat.

5. The external ballast fixture of claim 4, further comprising a row of ballast panel top vents.

6. The external ballast fixture of claim 5, further comprising a row of ballast panel bottom vents formed on the pair of sloped wing sections.

7. The external ballast fixture of claim 1, further comprising a pair of reflectors installed between the sidewalls of the top panel plate.

8. An external ballast fixture comprising:
a. a top panel plate having sidewalls;
b. lamp sockets connected to the top panel plate;
c. lamps mounted to the lamp sockets, wherein the sidewalls enclose the lamps;
d. a ballast panel opening formed on the top panel, wherein the ballast panel opening has a ballast panel opening left side and a ballast panel opening right side;
e. a ballast panel having a concave area, wherein the ballast panel has a ballast panel left edge and wherein the ballast panel has a ballast panel right edge, wherein the ballast panel left edge connects to the fixture top panel at a ballast panel opening left side and wherein the ballast panel right edge connects to the fixture top panel at a ballast panel opening right side;
f. a ballast housing mounted within the concave area of the ballast panel between the ballast panel left edge and the ballast panel right edge, wherein the ballast is exposed to the environment via the ballast panel opening;
g. a pair of reflectors installed between the sidewalls of the top panel plate, wherein each reflector of the pair of reflectors has a pair of channels.

9. The external ballast fixture of claim 8, further comprising a top panel plate located adjacent the ballast.

10. The external ballast fixture of claim 9, further comprising a knockout opening formed on the top panel plate.

11. The external ballast fixture of claim 8, further comprising a pair of sloped wing sections formed at the ballast panel concave area, wherein the sloped wing sections are flat.

12. The external ballast fixture of claim 11, further comprising a row of ballast panel top vents.

13. The external ballast fixture of claim 12, further comprising a row of ballast panel bottom vents formed on the pair of sloped wing sections.

14. An external ballast fixture comprising:
a. a top panel plate having sidewalls;
b. lamp sockets connected to the top panel plate;
c. lamps mounted to the lamp sockets, wherein the sidewalls enclose the lamps;
d. a ballast panel opening formed on the top panel, wherein the ballast panel opening has a ballast panel opening left side and a ballast panel opening right side;
e. a ballast panel having a concave area, wherein the ballast panel has a ballast panel left edge and wherein the ballast panel has a ballast panel right edge, wherein the ballast panel left edge connects to the fixture top panel at a ballast panel opening left side and wherein the ballast panel right edge connects to the fixture top panel at a ballast panel opening right side;
f. a ballast housing mounted within the concave area of the ballast panel between the ballast panel left edge and the ballast panel right edge, wherein the ballast is exposed to the environment via the ballast panel opening;
g. a pair of reflectors installed between the sidewalls of the top panel plate, wherein each reflector of the pair of reflectors has a pair of channels, wherein the ballast panel is bendable to engage with an underside of the top panel plate.

15. The external ballast fixture of claim 14, further comprising a top panel plate located adjacent the ballast.

16. The external ballast fixture of claim 15, further comprising a knockout opening formed on the top panel plate.

17. The external ballast fixture of claim 14, further comprising a pair of sloped wing sections formed at the ballast panel concave area, wherein the sloped wing sections are flat.

18. The external ballast fixture of claim 17, further comprising a row of ballast panel top vents.

19. The external ballast fixture of claim 18, further comprising a row of ballast panel bottom vents formed on the pair of sloped wing sections.
